(19) United States
(12) Patent Application Publication
(10) Pub. No.: US 2017/0287412 A1
(43) Pub. Date: Oct. 5, 2017

(54) ADJUSTABLE BACKLIGHT MODULE

(71) Applicant: WUHAN CHINA STAR OPTOELECTRONICS TECHNOLOGY CO., LTD., Wuhan (CN)

(72) Inventor: Yan Cheng, Wuhan (CN)

(21) Appl. No.: 15/331,247

(22) Filed: Oct. 21, 2016

(30) Foreign Application Priority Data
Apr. 1, 2016 (CN) 201620270807.1

(51) Int. Cl. G09G 3/34; F21V 8/00

(52) U.S. Cl. CPC G09G 3/3426; G02B 6/002; G02B 6/0073; G02B 6/0068; G02B 6/0055; G02B 6/005; G09G 2320/0633; G09G 2320/0666

(57) ABSTRACT

An adjustable backlight module comprises an image data gathering device; a user data gathering device; a data analyzing device connected to the image data gathering device and the user data gathering device; a controller connected to the data analyzing device; and a LCD backlight source connected to the controller. Based on the user's demands on the image brightness and color gamut, the present invention utilizes a controller and its driving circuit to control the LED chips of two colors individually for adjusting on and off of the LED chips and the intensity of light, thereby adjusting the brightness and color gamut of the entire module, and thus carrying out effective real-time control of the brightness and color gamut.

### TECHNICAL FIELD OF THE DISCLOSURE

The present invention relates to a backlight module for a liquid crystal display, and more particularly, to an adjustable backlight module.

### BACKGROUND OF THE DISCLOSURE

LCD backlight is a light source located in back of a liquid crystal display (LCD) and its luminance effect directly affects the visual performance of a liquid crystal module (LCM).

High color gamut is a common goal in current display design. Narrow color gamut and its corresponding color performance cannot meet diversified demand of customers. Generally speaking, the higher the color reproduction, the lower the lighting effect. That is, white light with a narrow color gamut is low in color reproduction and high in lighting effect; white light with a wide color gamut is high in color reproduction and low in lighting effect. That is, the color reproduction of a display is inversely proportional to the lighting effect (brightness). Therefore, how to carry out color gamut adjustment and at the same time balance it with the brightness of the display has become an importance topic in designing the backlight module.

In the existing skills, the backlight module of a LCD display usually adopts a monochrome LED chip (e.g., a blue chip) to cooperate with a monochrome fluorescent powder (e.g., yellow fluorescent powder) or a dual-color fluorescent powder (e.g., red fluorescent powder and green fluorescent powder) to carry out white light effect. Its disadvantage is that the display effect from such a backlight module is less well and the color gamut is narrow. Another approach is to adopt dual-color LED chips (e.g., a blue chip and a red chip) to cooperate with monochrome fluorescent powder (e.g., yellow fluorescent powder) to carry out white light effect and this approach leads to better color gamut. However, the afore-described approaches do not control the LED chips based on the user's demands on the image brightness and color gamut.

### SUMMARY OF THE DISCLOSURE

The objective of the present invention is to provide an adjustable backlight module, for solving the problems of narrow color gamut, low lighting effect, and poor control ability in the existing skills.

To achieve above objective, the present invention provides an adjustable backlight module, comprising: an image data gathering device; a user data gathering device; a data analyzing device connected to the image data gathering device and the user data gathering device; a controller connected to the data analyzing device; and a LCD (liquid crystal display) backlight source connected to the controller; wherein the LCD backlight source comprises a plurality of LED (light emitting diode) units; each LED unit comprises a blue chip and a red chip; all of the blue chips in the plural LED units are connected in series and the series of blue chips is connected to the controller; and all of the red chips in the plural LED units are connected in series and the series of red chips is connected to the controller.

Further, the image data gathering device comprises: an image brightness gathering module connected to the data analyzing device; and an image color gamut gathering module connected to the data analyzing device.

Further, the user data gathering device comprises: a user brightness gathering module connected to the data analyzing device; and a user color gamut gathering module connected to the data analyzing device.

The backlight module further comprises an input apparatus connected to the user data gathering device.

Further, backlight module comprises: a light guiding plate, the LCD backlight source being located on a lateral face of the light guiding plate; a bottom reflection plate disposed on a bottom surface of the light guiding plate; an optical film disposed above a top surface of the light guiding plate; and a fluorescent layer disposed between the LCD backlight source and the optical film. The fluorescent layer is located between the LCD backlight source and the light guiding plate, the fluorescent layer has a lateral face attached to the LCD backlight source, and another lateral face opposite to the lateral face of the fluorescent layer is attached to the light guiding plate. The fluorescent layer is located between the optical film and the light guiding plate, the fluorescent layer has a lateral face attached to the optical film, and another lateral face opposite to the lateral face of the fluorescent layer is attached to the light guiding plate.

Further, the fluorescent layer is a yellow fluorescent film or fluorescent tube.

The advantages of the present invention are that based on the user's demands on the image brightness and color gamut, the adjustable backlight module provided in the present invention utilizes a controller and its driving circuit to control the LED chips of two colors individually for adjusting on and off of the LED chips and the intensity of light, thereby adjusting the brightness and color gamut of the entire module, and thus carrying out effective real-time control of the brightness and color gamut. The present invention not only can adjust the color gamut anytime, but also can balance the brightness, thereby effectively improve the image quality of the display.

### BRIEF DESCRIPTION OF THE DRAWINGS

FIG. 1 is a schematic diagram showing a circuit structure according to an embodiment of the present invention.

FIG. 2 is a schematic diagram showing a structure according to an embodiment of the present invention.

FIG. 3 is a schematic diagram showing another structure according to an embodiment of the present invention.

### DETAILED DESCRIPTION OF THE DISCLOSURE

Preferred embodiments of the present invention will be described below with referring to the appending drawings to prove that the present invention is implementable. These embodiments are described for illustrations of the present invention for a person skilled in the art and make the technical schemes more clear and be easily understood. The present invention may be carried out by various embodiments constructed in different forms and the scope to be protected in the present invention is not limited to the embodiments just described in the context.

In the appending drawings, the components having the same structure are indicated by the same reference number and the components having similar structure or function are indicated by similar reference numbers. The size and thickness of each component in the drawings are illustrated in an arbitrary manner and are not limited in the present invention. In order to make the drawings more clear, some components are exaggerated in their thickness in the drawings.

In descripting the present invention, spatially relative terms such as “upper”, “lower”, “front”, “back”, “left”, “right”, “inner”, “outer”, “lateral”, and the like, may be used herein for ease of description as illustrated in the figures. These spatially relative terms are merely used to explain and illustrate the present invention and are not used to limit the scope thereof.

When a certain component is described to be “on” another component, said component may be located directly on said another component. Also, there may exist an intermediate component, said component is located on said intermediate component, and said intermediate component is located on said another component. When a certain component is described to be “mounted on” or “connected to” another component, it may be construed to be directly “mounted on” or directly “connected to”; or else, said component is “mounted on” or “connected to” said another component via an intermediate component.

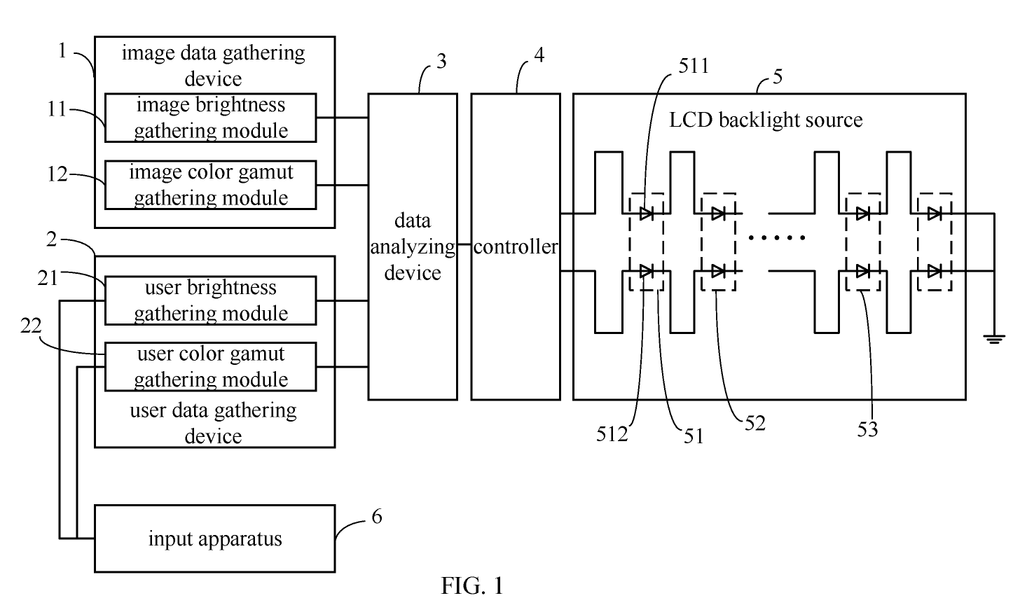

As shown in FIG. 1, the present invention provides an adjustable backlight module, which comprises an image data gathering device 1, a user data gathering device 2, a data analyzing device 3, a controller 4, a LCD (liquid crystal display) backlight source 5, and an input apparatus 6.

The image data gathering device 1 comprises an image brightness gathering module 11 connected to the data analyzing device 3. The image brightness gathering module 11 is configured to gather the brightness data of real-time images presented on a display and transmit the brightness data of real-time images to the data analyzing device 3. The image data gathering device 1 further comprises an image color gamut gathering module 12 connected to the data analyzing device 3. The image color gamut gathering module 12 is configured to gather the color gamut data of real-time images presented on the display and transmit the color gamut data of real-time images to the data analyzing device 3.

The user data gathering device 2 comprises a user brightness gathering module 21 connected to the data analyzing device 3. The user brightness gathering module 21 is configured to gather the brightness data of image required by a user and transmit the brightness data of image required by the user to the data analyzing device 3. The user data gathering device 2 further comprises a user color gamut gathering module 22 connected to the data analyzing device 3. The user color gamut gathering module 22 is configured to gather the color gamut data of image required by the user and transmit the color gamut data of image required by the user to the data analyzing device 3. The input apparatus 6 is connected to the user data gathering device 2, and more specifically, to the user brightness gathering module 21 and the user color gamut gathering module 22. The input apparatus 6 is provided for the user to input a desired image data including the brightness and the color gamut of image. The input apparatus 6 can be a keyboard or a touchscreen.

The data analyzing device 3 itself is a data processor. After obtaining the afore-described data from the image data gathering device 1 and the user data gathering device 2, the data analyzing device 3 compares and analyzes related data. The data analyzing device 3 compares the image brightness required by the user with current image brightness and their difference is an image brightness correction data (brightness value required to be adjusted). It is assumed that current image brightness is S cd/m² and the image brightness required by the user is T cd/m². If S is smaller than T, it needs to increase the image brightness with an amount of (T−S) cd/m² and the data analyzing device 3 calculates, according to related formulas, the amount of electric current passing the LCD backlight source required to be increased. If S is greater than T, it needs to decrease the image brightness with an amount of (S−T) cd/m² and the data analyzing device 3 calculates, according to related formulas, the amount of electric current passing the LCD backlight source required to be decreased. If S is equal to T, it does not need to make any adjustment. The data analyzing device 3 compares the color gamut required by the user with current color gamut of image and their difference is an image color gamut correction data (color gamut value required to be adjusted). The data analyzing device 3 calculates based on related formulas and determines to increase or decrease the electric current passing a blue chip and/or a red chip, or not to adjust it. After the comparison, analysis, and calculation, the data analyzing device 3 can conclude to increase or decrease the electric current passing the blue chip, or not to adjust it, and conclude to increase or decrease the electric current passing the red chip, or not to adjust it.

The LCD backlight source 5 is connected to the data analyzing device 3 via the controller 4. The LCD backlight source 5 comprises a plurality of LED (light emitting diode) units 51, 52, 53, . . . , etc. Each LED unit comprises a blue chip and a red chip. For example, the LED unit 51 comprises the blue chip 511 and the red chip 512. All of the blue chips in the plural LED units are connected in series and the series of blue chips is connected to the controller 4. All of the red chips in the plural LED units are connected in series and the series of red chips is connected to the controller 4. The controller 4 can simultaneously control or adjust the luminance power for all of the blue chips and all of the red chips.

The controller 4 itself is a LED driving control circuit. The controller 4 obtains the analysis results from the data analyzing device 3 and transmits control instructions to the blue chips and/or the red chips in the LCD backlight source 5 for adjusting real-time electric current passing the blue chips and/or the red chips, thereby achieving the objective of brightness and/or color gamut adjustment of the display.

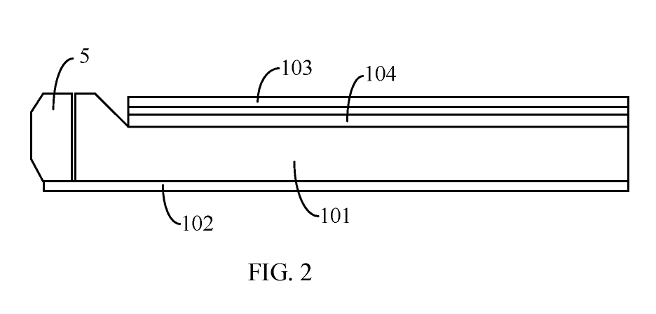

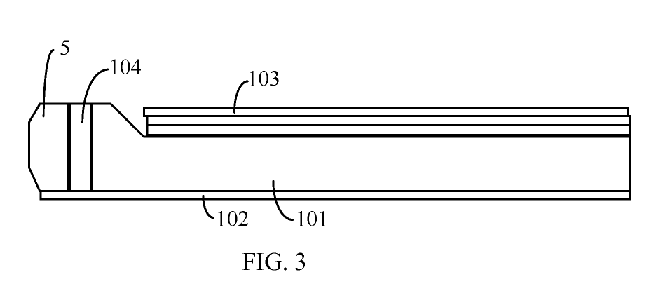

As shown in FIG. 2, the present embodiment may also comprise a light guiding plate 101, the LCD backlight source 5 being located on a lateral face of the light guiding plate 101; a bottom reflection plate 102 disposed on a bottom surface of the light guiding plate 101; an optical film 103 disposed above a top surface of the light guiding plate 101; and a fluorescent layer 104 disposed between the LCD backlight source 5 and the optical film 103. The fluorescent layer 104 is a yellow fluorescent film or fluorescent tube. The fluorescent layer 104 can also be a quantum-dot dielectric layer. Specifically, the fluorescent layer 104 may be located between the LCD backlight source 5 and the light guiding plate 101. The fluorescent layer 104 has a lateral face attached to the LCD backlight source 5, and another lateral face opposite to the lateral face of the fluorescent layer 104 is attached to the light guiding plate 101. A mixture of pure blue light and pure red light cannot form the white light, and therefore it requires yellow fluorescent powder to provide pure yellow light. As shown in FIG. 3, the fluorescent layer 104 may be located between the optical film 103 and the light guiding plate 101. The fluorescent layer 104 has a lateral face attached to the light guiding plate 101, and another lateral face opposite to the lateral face of the fluorescent layer 104 is attached to the optical film 103.

The technical effects of the present invention are that based on the user's specific demands on the image brightness and color gamut, the present invention utilizes a controller and its driving circuit to adjust the electric current and output power of the LED chips, thereby adjusting the image brightness and color gamut of the display in time. Meanwhile, under unchanged amount of LEDs, the brightness of a single piece of LED is increased, thereby improving the image quality, simplifying the operations, and providing convenience in use.

Above descriptions are preferred embodiments of the present invention. It should be noted that various modifications and alterations can be made by persons skilled in this art without departing from the principles of the present invention, and that all modifications and alterations are within the scope of the present invention.

What is claimed is:

1. An adjustable backlight module, comprising:
an image data gathering device;
a user data gathering device;
a data analyzing device connected to the image data gathering device and the user data gathering device;
a controller connected to the data analyzing device; and
a LCD (liquid crystal display) backlight source connected to the controller;
wherein the LCD backlight source comprises a plurality of LED (light emitting diode) units; each LED unit comprises a blue chip and a red chip; all of the blue chips in the plural LED units are connected in series and the series of blue chips is connected to the controller; and all of the red chips in the plural LED units are connected in series and the series of red chips is connected to the controller.

2. The adjustable backlight module according to claim 1, wherein the image data gathering device comprises:
an image brightness gathering module connected to the data analyzing device; and
an image color gamut gathering module connected to the data analyzing device.

3. The adjustable backlight module according to claim 1, wherein the user data gathering device comprises:
a user brightness gathering module connected to the data analyzing device; and
a user color gamut gathering module connected to the data analyzing device.

4. The adjustable backlight module according to claim 1, further comprising an input apparatus connected to the user data gathering device.

5. The adjustable backlight module according to claim 1, further comprising:
a light guiding plate, the LCD backlight source being located on a lateral face of the light guiding plate;
a bottom reflection plate disposed on a bottom surface of the light guiding plate;
an optical film disposed above a top surface of the light guiding plate; and
a fluorescent layer disposed between the LCD backlight source and the optical film.

6. The adjustable backlight module according to claim 5, wherein the fluorescent layer is located between the LCD backlight source and the light guiding plate, the fluorescent layer has a lateral face attached to the LCD backlight source, and another lateral face opposite to the lateral face of the fluorescent layer is attached to the light guiding plate.

7. The adjustable backlight module according to claim 5, wherein the fluorescent layer is located between the optical film and the light guiding plate, the fluorescent layer has a lateral face attached to the optical film, and another lateral face opposite to the lateral face of the fluorescent layer is attached to the light guiding plate.

8. The adjustable backlight module according to claim 5, wherein the fluorescent layer is a yellow fluorescent film or fluorescent tube.

9. The adjustable backlight module according to claim 6, wherein the fluorescent layer is a yellow fluorescent film or fluorescent tube.

10. The adjustable backlight module according to claim 7, wherein the fluorescent layer is a yellow fluorescent film or fluorescent tube.
